(19) United States
(12) Patent Application Publication
(10) Pub. No.: US 2015/0367317 A1
(43) Pub. Date: Dec. 24, 2015

(54) UV Gel Curing Apparatus and LED Light Tube for Use in the Same

(71) Applicant: Kyoo-Cheon HWANG, Bucheon-si (KR)

(72) Inventor: Kyoo-Cheon HWANG, Bucheon-si (KR)

(21) Appl. No.: 14/504,193

(22) Filed: Oct. 1, 2014

(30) Foreign Application Priority Data
Jun. 19, 2014 (KR) 10-2014-0074694

(51) Int. Cl. B01J 19/12; A45D 29/00

(52) U.S. Cl. CPC B01J 19/123; A45D 29/00

(57) ABSTRACT

The UV nail gel curing apparatus includes a UV light tube and a body having a UV light tube receptacle. The UV light tube may be an UV light bulb or a UV LED light tube. The UV LED light tube includes a housing, a circuit board and pins fixed to the circuit board. The pins can be electrically connected to the gel curing apparatus. The circuit board includes a part hole to receive a large part such as a capacitor or a condenser. Furthermore, heat dissipation holes are formed on the circuit board right next to each of the LEDs for dissipating heat generated by the LEDs.

### CROSS-REFERENCE TO RELATED APPLICATIONS

This application claims the benefit of Korean Application No. 10-2014-0074694, filed on Jun. 19, 2014, with the Korean Intellectual Property Office, the disclosure of which is incorporated herein by reference.

### FIELD OF THE INVENTION

The present invention relates to an ultraviolet (UV) nail gel curing apparatus and a light-emitting diode (LED) light tube for use in a UV nail gel curing apparatus. UV light bulbs, which have a wavelength of about 365 nm, have been conventionally used for curing UV nail gels, but LED-based nail gel curing apparatuses, which have a wavelength of about 400 nm, have been recently introduced for curing LED nail gels. Even though 365 nm and 400 nm wavelength lights are called the same name of ‘UV light’, to prevent confusion in the nail art and nail polish industry, 365 nm UV gels are called ‘UV gels’ whereas 400 nm UV gels are called ‘LED gels’. Because both of the conventional UV nail gels and the new LED nail gels are generally being used for nail treatments, nail gel consumers, who include nailists or nail technicians, have to purchase and carry both types of nail gel apparatuses. Accordingly, the present invention is directed to an LED light tube which is compatible with and can be used with a conventional UV nail gel curing apparatus to cure LED nail gels.

### BACKGROUND OF THE INVENTION

People use nail coatings to cosmetically enhance the appearance of their nails or protect their nails. Among many types of nail coatings, UV nail gels and LED nail gels have been developed and introduced and light is used to cause a chemical reaction in the gels that result in the formation of a long-lasting, highly-durable nail coating.

A UV lamp has been generally used to radiate UV wavelength for the curing of UV gel. However, such UV lamp has some shortcomings: overheating or poor heat elimination, long curing time, and shorter service life of the lamp.

To overcome the shortcomings, a UV LED lamp has been developed and introduced even if it has a somewhat different wavelength because of an economic reason. The heat generated by an LED lamp is much less than that of UV lamp. The curing effect of UV gel by an LED lamp is much better and the curing time is shorter. In addition, the replacement frequency and cost of the lamps are relatively lower because of the longer service life of the LED lamps. Accordingly, the conventional UV lamps have been gradually replaced by LEDs.

However, the conventional UV lamps still have some advantages over the LED lamps and consumers often carry both the conventional UV lamp and the LED lamp. Having both types of lamps causes some problems such as increased cost and inconvenience caused by using two lamps.

Therefore, to solve the above problems, there have been needs for a UV nail gel curing apparatus compatible both with a conventional UV light bulb and a UV LED light tube and for a light-emitting diode (LED) light tube for use in a conventional UV nail gel curing apparatus. This invention is directed to solve these problems and satisfy the long-felt need.

### SUMMARY OF THE INVENTION

The present invention contrives to solve the disadvantages of the prior art. The present invention provides a UV LED light tube for curing nail gels. The UV LED light tube includes pins which can be electrically connected to a power source. The pins are identical to those used for conventional UV light bulbs. The number of pins may be two, three, or four. Thus, the UV LED light tube of the present invention can be used instead of a conventional UV light bulb.

The object of the invention is to provide a UV LED light tube for curing LED nail gels. The UV LED light tube includes a housing, a circuit board provided in the housing, LEDs provided on the circuit board, and a pin(s) fixed to the circuit board. The circuit board includes a pin hole to receive the pin. The pin is cylindrical and an end of the pin is flattened and curved so that the flattened and curved end of the pin is inserted into the pin hole and fixedly attached to the circuit board by soldering.

Another object of the invention is to provide a UV LED light tube for curing nail gels. The UV LED light tube includes a housing, a circuit board provided in the housing, LEDs provided on the circuit board, and a pin(s) fixed to the circuit board. The circuit board includes a part hole to receive a part such as a capacitor or a condenser. Capacitor or condenser is very large part compared to the size of the UV LED light tube and thus, the structure of part hole can make the size of the light tube much smaller and slimmer.

Still another object of the invention is to provide a UV LED light tube for curing nail gels, which includes a plurality of heat dissipation holes formed on the circuit board right next to each of the LEDs for dissipating heat generated by the LEDs.

Still another object of the invention is to provide a UV nail gel curing apparatus, which includes a UV light tube, a body having a UV light tube receptacle, a hand rest, a heat dissipation opening, and a switch, and a pair of legs. The UV light tube may be a UV light bulb or a UV LED light tube.

The advantages of the present invention are: (1) the UV nail gel curing apparatus of the present invention is compatible not just with a conventional UV light bulb, but also with the LED light tube of the present invention; (2) it is easy and convenient to attach or detach different kinds of UV lights to the UV nail gel curing apparatus of the present invention; (3) the LED light tube of the present invention includes pins attached to the circuit board of the light tube and the pins enable the LED light tube compatible with conventional UV light bulbs; (4) the LED light tube of the present invention includes a circuit board having a part hole to receive a large part such as a capacitor or a condenser, and thus, the thickness of the LED light tube is much smaller and this construction helps easy attachment and detachment of the light tube to the UV nail gel curing apparatus; (5) the LED light tube of the present invention includes a plurality of heat dissipation holes formed on the circuit board right next to each of the LEDs for dissipating heat generated by the LEDs; (6) due to the effective heat dissipation structure of the present invention, the service life of the LEDs in the present invention is longer; (7) the present invention makes nail gel curing time shorter; and (8) the present invention prevents a user's hand or wrist from slipping and it is easy and convenient to store or contain brushes or adhesives.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a perspective view of a UV nail gel curing apparatus according to one embodiment of the present invention;

FIG. 2 shows another perspective view of the UV nail gel curing apparatus;

FIG. 3 shows a front view of an LED light tube for use in a UV nail gel curing apparatus according to one embodiment of the present invention;

FIG. 4 shows an exploded view of the LED light tube of FIG. 3;

FIG. 5 shows an LED circuit board of the LED light tube of FIG. 3;

FIG. 6 shows a front view of an LED light tube for use in a UV nail gel curing apparatus according to another embodiment of the present invention;

FIG. 7 shows an exploded view of the LED light tube of FIG. 6; and

FIG. 8 shows an LED circuit board of the LED light tube of FIG. 6.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the term “or” is used to refer to a nonexclusive or, unless otherwise indicated. Moreover, unless explicitly stated to the contrary, embodiments “comprising” or “having” an element or a plurality of elements having a particular property may include additional such elements not having that property.

As used herein, the term “light tube” refers to means for providing light inserted into a lamp or other light emitting structure. Light tube includes light bulb, glass bulb, UV light tube, LED light tube, UV light bulb, LED light bulb, etc.

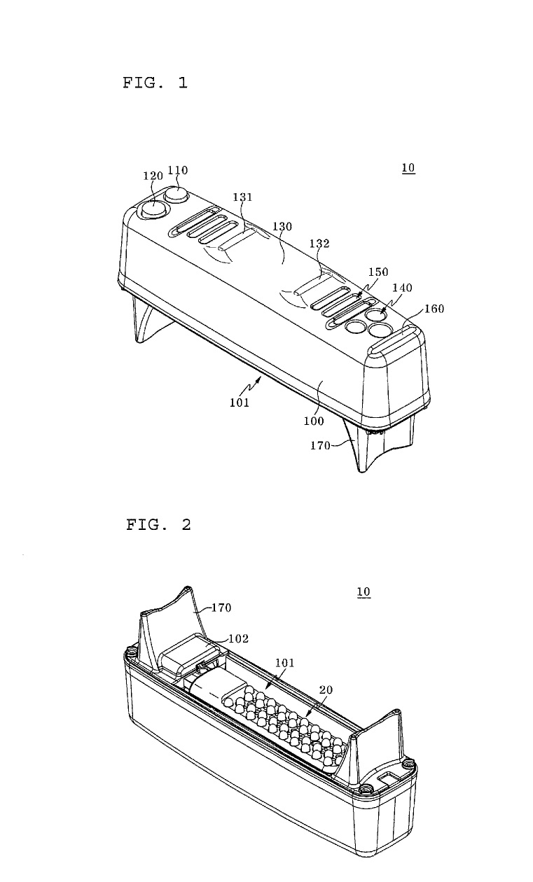

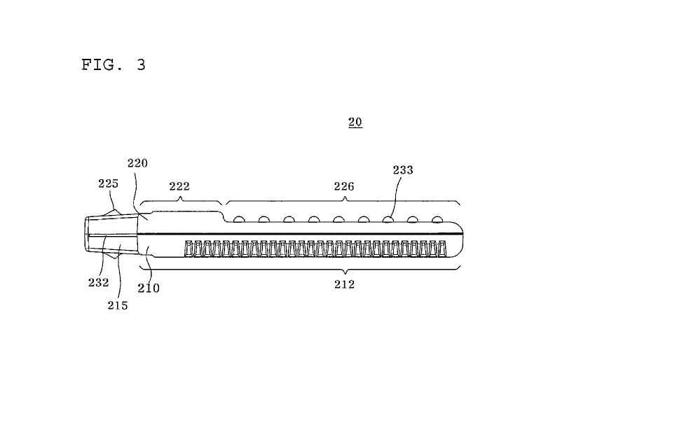

FIGS. 1 and 2 respectively show top and bottom perspective views of a UV nail gel curing apparatus 10 according to one embodiment of the present invention.

The UV nail gel curing apparatus 10 of the present invention includes a UV light tube 20, a body 100, and legs 170. The body 100 includes a UV light tube receptacle 101, a hand rest 130, a heat dissipation opening 150, a switch 110 and a fuse 120. The UV light tube 20 may be a conventional UV light bulb or a UV LED light bulb. The UV light tube 20 is received in the UV light tube receptacle 101 and electrically connected to the body 100. The body 100 may be electrically connected to an outside power source or it may have such power source such as a battery therein. The UV light tube 20 faces downward so that UV light emits downward and nail gel applied fingernail or toenail is placed between the legs for curing nail gel.

The switch 110 turns on and/or off the UV light tube 20, preferably being located on an end of the body 100. The switch 110 is preferably a button configured in that if the button 110 is pressed one time, the UV light tube 20 illuminates for a predetermined time, and if the button 110 is pressed two times, the UV light tube 20 illuminates for double the predetermined time. The predetermined time may be about 20 seconds.

The switch 110 may be programmed in a number of different ways, but preferably if pressed one time, the light tube 20 illuminates for about 20 seconds and if pressed two times, the light tube 20 illuminates for about 40 seconds. If the switch 110 is pressed three times, the light tube 20 illuminates for about 60 seconds, and if pressed four times, the light tube 20 is turned off. In this way, the switch is very easy-to-use.

The body 100 includes a light tube connector 102 and the light tube 20 includes a connector 215, 225. The connector 215, 225 is mated with the light tube connector 102 and the pins 232 are electrically connected to the body 100. The connector 215, 225 may further comprise a locking protrusion for secure connection to the light tube connector 102.

The hand rest 130 is where a user can rest her hand or wrist while treating her fingernails and a couple of hand supports 131, 132 are provided on both ends of the hand rest 130 to support her hand or wrist. Preferably, the hand supports 131, 132 are configured to form protrusions raised from a surface of the body 100.

The heat dissipation holes 150 are formed on upper surface of the body 100, preferably on both sides of the hand rest 130. The heat dissipation holes 150 dissipate heat generated from the UV light tube 20 in order to prevent accumulation of heat onto a user's fingernails.

The UV nail gel curing apparatus 10 may further comprise a brush holder 160 and/or an adhesive container 140 formed on the body 100. The brush holder 160 is to hold a brush(s) which is used to treat a fingernail and the adhesive container 140 is to hold an adhesive. It is convenient for the nail gel curing apparatus 10 to have an adhesive container 140 therein because it is better for the distance between the fingernails and the adhesive container to be close in order to prevent the adhesive from flowing down. One or more of the heat dissipation holes 150 may be formed as the brush holder 160 or the adhesive container 140.

The UV light tube receptacle 101 is to receive the light tube 20 therein and located at the bottom of the body 100 so that the light tube 20 illuminates downward and cure gels on fingernails placed between the legs 170. The UV light tube receptacle 101 may be rectangular or round or in a variety of different shapes.

The light tube connector 102 is protruded downward so that the UV light tube can be close to nail gel treated fingernails.

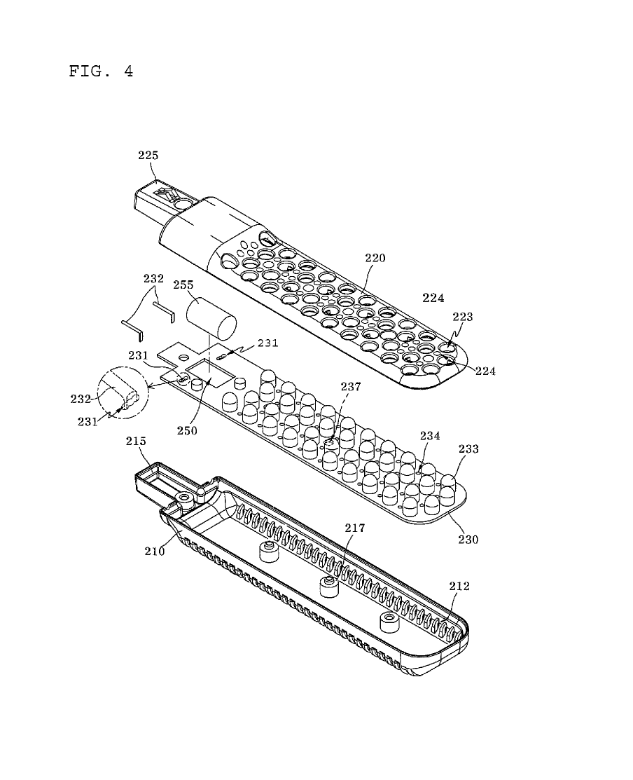

FIG. 3 shows a front view of an LED light tube 20 for use in a UV nail gel curing apparatus 10 according to one embodiment of the present invention. FIG. 4 shows an exploded view of the LED light tube 20 and FIG. 5 shows an LED circuit board 230 of the LED light tube 20.

The UV LED light tube 20 of the present invention includes a housing 210, 220; a circuit board 230 provided in the housing 210, 220; a plurality of LEDs 233 fixedly provided on and electrically connected to the circuit board 230; at least one pin 232 fixedly attached to and electrically connected to the circuit board 230. The housing 210, 220 has a lower case 210 and an upper case 220 and the lower case 210 and an upper case 220 are mated with each other to form the housing 210, 220. In addition, the LEDs 233 are ultraviolet (UV) LEDs for curing nail gels.

The circuit board 230 comprises at least one pin hole 231 to receive the pin 232 therein and the pin hole 231 may be rectangular or in a shape of overlapping circles or any other shape suitable to receive the pin 232. If the pin hole 231 is overlapping circles, it can be made by punching the circuit board 230 two or three times to make two or three overlapping circles.

The pin 232 may be cylindrical and an end of the pin 232 may be flattened and curved. Then, the flattened and curved end of the pin 232 may be inserted into the pin hole 231 and fixedly attached to the circuit board 230 by soldering, for example, lead soldering. By soldering, the pin 232 can be electrically connected to the circuit board 230.

The circuit board 230 may further comprise a part hole 250 to receive a part 255 therein. The part 255 is generally a large one such as a capacitor 255 or a condenser 255. Large part of the circuit board 230 can make the LED light tube 20 large as well and thus, the structure of part hole 250 to receive a large part 255 can make the size of the light tube 20 much smaller and slimmer. Especially, because of the part hole 250, the depth of the LED light tube 20 can be smaller and this structure is advantageous in that it is easier and more convenient to attach and/or detach the light tube 20 to the nail gel curing apparatus 10.

The circuit board 230 may further include a plurality of heat dissipation holes 234 in that the plurality of heat dissipation holes 234 are respectively formed near or next to the plurality of LEDs 233 for dissipating heat generated by the LEDs 233. Furthermore, the plurality of heat dissipation holes 234 may be filled with material having a high heat transfer rate to much increase heat dissipation rate. The material may be lead or other metallic material as long as it has high heat transfer rate.

Heat generated from the LEDs 233 transfers through the heat dissipation holes 234 and dissipates outside through the lower heat dissipation part 212. Due to this structure, LED's performance is much better and the service life of LED and other parts becomes much longer.

Preferably, the heat dissipation hole 234 is filled with lead and the diameter of the heat dissipation hole 234 is 1 mm or less. This structure of heat dissipation hole 234 filled with lead is easy to manufacture and the cost is very small. Yet, its heat dissipation performance is very excellent. In one experiment, the temperature in the lower case 210 has decreased by at least 5 Celsius.

The lower case 210 may include a lower heat dissipation part 212 and the heat dissipation part 212 may include a plurality of heat dissipation fins and a plurality of lower heat dissipation holes formed along the heat dissipation fins.

The lower case 210 may further include a protrusion 217 which is fixed to the protrusion hole 237 of the circuit board 230. The protrusion 217 keeps the circuit board 230 in place at around middle of the LED light tube 20. Alternatively, the lower case 210 may include a lead to fix the circuit board 230 in place.

The upper case 220 includes first heat dissipation part 226 and the second heat dissipation part 222 and the first heat dissipation part 226 includes a plurality of upper heat dissipation holes 224 to release and dissipate heat. The upper case 220 further includes a plurality of LED holes 223 to receive LEDs 233 therein and the LEDs 233 are inserted in the LED holes 223 and exposed outside. The second heat dissipation part 222 includes at least one hole and even if a large part 255 such as a capacitor is located below, the depth of the second heat dissipation part 222 is not that great because the part 255 is located in the part hole 250.

The circuit board 230 is located in between the upper case 220 and the lower case 210 at around the middle of the LED light tube 20. In this structure, the area of the circuit board 230 can be maximized and large area of circuit board 230 is advantageous in greater heat dissipation especially by convection.

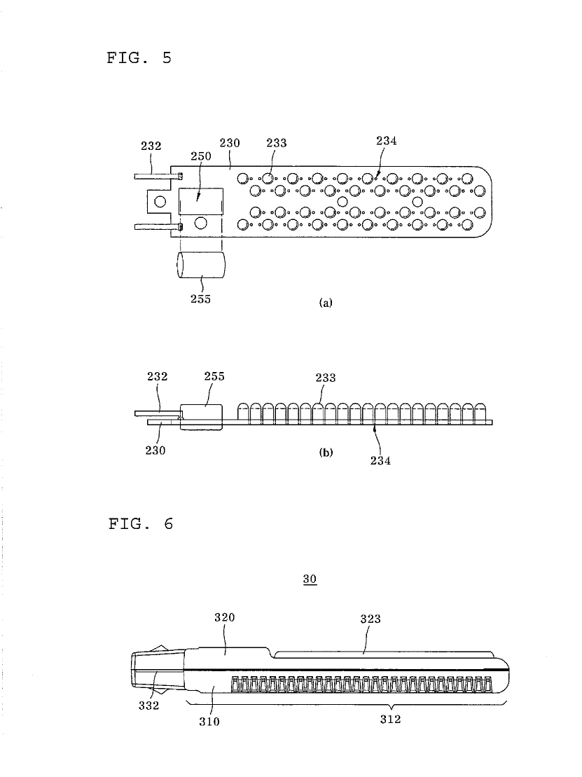

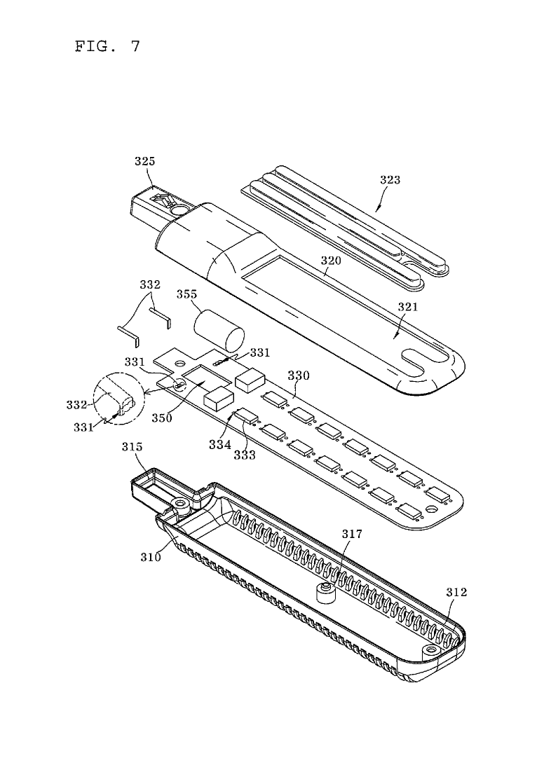

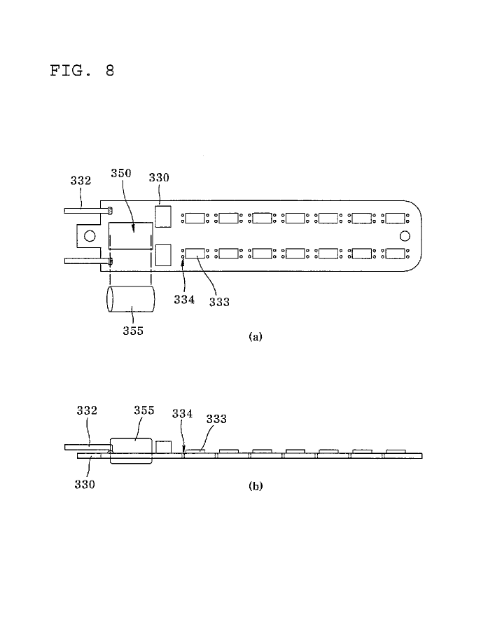

FIG. 6 shows a front view of an LED light tube 30 for use in a UV nail gel curing apparatus 10 according to another embodiment of the present invention. FIG. 7 shows an exploded view of the LED light tube 30 and FIG. 8 shows an LED circuit board 330 of the LED light tube 30.

The UV LED light tube 30 includes a housing 310, 320; a circuit board 330, LEDs 333 provided on the circuit board 330, at least one pin 332 attached to the circuit board 330. The housing 310, 320 has a lower case 310 and an upper case 320 and the lower case 310 and an upper case 320 are mated with each other to form the housing 310, 320.

The circuit board 330 comprises at least one pin hole 331 to receive the pin 332 therein and the pin hole 331 may be rectangular or in a shape of overlapping circles or any other shape suitable to receive the pin 332.

The pin 332 may be cylindrical and an end of the pin 332 may be flattened and curved. Then, the flattened and curved end of the pin 332 may be inserted into the pin hole 331 and fixedly attached to the circuit board 330 by soldering.

The circuit board 330 may further comprise a part hole 350 to receive a part 355 therein. The part 355 is generally a large one such as a capacitor 355 or a condenser 355.

The circuit board 330 may further include a plurality of heat dissipation holes 334 in that the plurality of heat dissipation holes 334 are respectively formed near or next to the plurality of LEDs 333 for dissipating heat generated by the LEDs 233. Furthermore, the plurality of heat dissipation holes 334 may be filled with material having a high heat transfer rate to much increase heat dissipation rate. Preferably, four heat dissipation holes 334 may be formed right next to each LED 333 as shown in FIG. 7.

The lower case 310 may include a lower heat dissipation part 312 and the heat dissipation part 312 may include a plurality of heat dissipation fins and a plurality of lower heat dissipation holes formed along the heat dissipation fins.

The UV LED light tube 30 may further comprise a lens 323 provided on or above the plurality of LEDs 333. The upper case 320 includes a lens hole 321 to receive the lens 323 therein. The plurality of LEDs 333 may be arranged in adjacent rows as in FIG. 7 and the lens 323 may include longitudinal convex ridges at least as many as the number of rows of the LEDs 333. As in FIG. 7, when there are two rows of LEDs 333, there may be three convex ridges on the lens 323. The lens 323 concentrates the UV light from the LEDs 333 toward a specific angle and this concentration improves the nail curing performance.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A light-emitting diode (LED) light tube, comprising:
a housing including a lower case and an upper case wherein the lower case and an upper case are mated with each other to form the housing;
a circuit board provided in the housing;
a plurality of LEDs fixedly provided on and electrically connected to the circuit board;
at least one pin fixedly attached to and electrically connected to the circuit board.

2. The LED light tube of claim 1, wherein the LEDs are ultraviolet (UV) LEDs for curing nail gels.

3. The LED light tube of claim 1, wherein the circuit board comprises at least one pin hole to receive the pin therein and the pin hole is rectangular or in a shape of overlapping circles.

4. The LED light tube of claim 3, wherein the pin is cylindrical and an end of the pin is flattened and curved, and
wherein the flattened and curved end of the pin is received in the pin hole and fixedly attached to the circuit board by soldering.

5. The LED light tube of claim 1, wherein the circuit board comprises a part hole to receive a part therein.

6. The LED light tube of claim 5, wherein the part is a capacitor or a condenser.

7. The LED light tube of claim 1, wherein the circuit board further comprises a plurality of heat dissipation holes wherein the plurality of heat dissipation holes are respectively formed near the plurality of LEDs for dissipating heat generated by the LEDs.

8. The LED light tube of claim 7, wherein the plurality of heat dissipation holes are filled with material having a high heat transfer rate.

9. The LED light tube of claim 1, further comprising a lens provided on or above the plurality of LEDs.

10. The LED light tube of claim 9, wherein the plurality of LEDs are arranged in adjacent rows and the lens comprises longitudinal convex ridges at least as many as the number of rows of the LEDs.

11. The LED light tube of claim 1, wherein the lower case comprises a heat dissipation part.

12. The LED light tube of claim 1, wherein the heat dissipation part comprises a plurality of heat dissipation fins and a plurality of lower heat dissipation holes formed along the heat dissipation fins.

13. An ultraviolet (UV) nail gel curing apparatus, comprising:
a UV light tube;
a body including a UV light tube receptacle, a hand rest, a heat dissipation opening, and a switch; and
a pair of legs,
wherein the UV light tube is received in the UV light tube receptacle and electrically connected to the body,
wherein the UV light tube faces downward such that UV light emits downward and nail gel applied fingernail or toenail is placed between the legs for curing nail gel.

14. The UV nail gel curing apparatus of claim 13, wherein the body further comprises a brush holder and an adhesive container.

15. The UV nail gel curing apparatus of claim 13, wherein the UV light tube is an UV light-emitting diode (LED) light tube, comprising:
a housing including a lower case and an upper case wherein the lower case and an upper case are mated with each other to form the housing;
a circuit board provided in the housing;
a plurality of LEDs fixedly provided on and electrically connected to the circuit board;
at least one pin fixedly attached to and electrically connected to the circuit board,
wherein the circuit board comprises at least one pin hole to receive the pin therein and the pin hole is rectangular or in a shape of overlapping circles,
wherein the pin is cylindrical and an end of the pin is flattened and curved, and
wherein the flattened and curved end of the pin is received in the pin hole and fixedly attached to the pin hole by soldering.

16. The UV nail gel curing apparatus of claim 15, wherein the switch is a button configured such that if the button is pressed one time, the UV light tube illuminates for a predetermined time, and if the button is pressed two times, the UV light tube illuminates for double the predetermined time.

17. The UV nail gel curing apparatus of claim 16, wherein the predetermined time is about 20 seconds.

18. The UV nail gel curing apparatus of claim 15, wherein the circuit board comprises a part hole to receive a part therein, and the part is a capacitor or a condenser.

19. The UV nail gel curing apparatus of claim 15, wherein the circuit board further comprises a plurality of heat dissipation holes wherein the plurality of heat dissipation holes are respectively formed near the plurality of LEDs for dissipating heat generated by the LEDs,
wherein the plurality of heat dissipation holes are filled with material having a high heat transfer rate.

20. The UV nail gel curing apparatus of claim 15, wherein the UV light tube further comprises a lens provided on or above the plurality of LEDs,
wherein the plurality of LEDs are arranged in adjacent rows and the lens comprises longitudinal convex ridges at least as many as the number of rows of the LEDs.
